(19) United States
(12) Patent Application Publication
(10) Pub. No.: US 2015/0169993 A1
(43) Pub. Date: Jun. 18, 2015

(54) GEOMETRY-PRESERVING VISUAL PHRASES FOR IMAGE CLASSIFICATION USING LOCAL-DESCRIPTOR-LEVEL WEIGHTS

(71) Applicant: Google Inc., Mountain View, CA (US)

(72) Inventors: Andrew Rabinovich, San Diego, CA (US); Alexander Toshkov Toshev, San Francisco, CA (US)

(73) Assignee: Google Inc., Mountain View, CA (US)

(21) Appl. No.: 13/632,654

(22) Filed: Oct. 1, 2012

(51) Int. Cl. G06K 9/62; G06K 9/46; G06F 17/30

(52) U.S. Cl. CPC G06K 9/6215; G06K 9/6267; G06F 17/3028; G06K 9/46

(57) ABSTRACT

Implementations relate to techniques for classifying images. Some techniques utilize weights associated with local descriptors to classify images. Some techniques utilize visual phrase matching to classify images. The resulting image classifications can be used in part to assist in internet searches.

### BACKGROUND

The techniques provided herein relate to classifying images.

Search engines allow users to search for images using search queries. Such search engines can use indexes to match search queries with images.

### SUMMARY

According to some implementations, a method is presented. The method includes associating a weight to each of a plurality of local descriptors, each local descriptor associated with an image of a plurality of images, each image of the plurality of images classified in at least one of a plurality of image classes, each of the image classes including a plurality of stored images. The method also includes generating, for each image class, an index, each index including a plurality of local descriptors associated with images in a respective image class to generate a plurality of indexes. The method further includes obtaining a query image, determining, using an index of the plurality of indexes, a query image cost for a candidate image class, and associating, based on the determining, a label for the candidate image class with the query image.

The above implementations can optionally include one or more of the following. Each weight can include a cardinality of a geometry-preserving visual phrase. Each weight can include a number of repetitions of the geometry-preserving visual phrase among offset spaces associated with images in an image class. The query image cost can include a weight associated with a descriptor associated with an image in the candidate image class. The query image cost can include a distance between the descriptor associated with an image in the candidate image class and a descriptor associated with the query image. The method can further include receiving a textual search query, and providing the query image in response to the receiving. The query image cost can include a sum of local descriptor costs. The query image cost for the candidate image class is one of maximal and minimal as compared with a plurality of additional query image costs for a plurality of other image classes.

According to some implementations, a system is presented. The system includes a persistent memory storing a plurality of images, each image of the plurality of images stored in association with a classification in at least one of a plurality of image classes, each of the image classes including a plurality of stored images. The system also includes at least one processor configured to compute, for each of a plurality of local descriptors, each local descriptor associated with an image, a weight. The system further includes a persistent memory storing, for each image class, an index, each index including a plurality of local descriptors associated with images in a respective image class, so that a plurality of indexes are stored. The system further includes at least one processor configured to determine, using an index of the plurality of indexes, a query image cost for a candidate image class. The system further includes at least one processor configured to associate, based on the query image cost, the candidate image class with the query image. The system further includes a persistent memory storing an indicia associated with the candidate image class in association with the query image.

The above implementations can optionally include one or more of the following. Each weight can include a cardinality of a geometry-preserving visual phrase. Each weight can include a number of repetitions of the geometry-preserving visual phrase among offset spaces associated with images in an image class. The query image cost can include a weight associated with a descriptor associated with an image in the candidate image class. The query image cost can include a distance between the descriptor associated with an image in the candidate image class and a descriptor associated with the query image. The system can include a network interface configured to receive a textual search query, and at least one processor configured to provide the query image in response to the textual search query. The query image cost can include a sum of local descriptor costs. The query image cost for the candidate image class can be one of maximal and minimal as compared with a plurality of additional query image costs for a plurality of other image classes.

According to some implementations, a computer readable medium is presented. The computer readable medium includes instructions which, when executed, cause at least one processor to: associate a weight to each of a plurality of local descriptors, each local descriptor associated with an image of a plurality of images, each image of the plurality of images classified in at least one of a plurality of image classes, each of the image classes including a plurality of stored images, generate, for each image class, an index, each index including a plurality of local descriptors associated with images in a respective image class, to store a plurality of indexes, obtain a query image, determine, using an index of the plurality of indexes, a query image cost for a candidate image class, and associate, based on the query image cost, a label for the candidate image class with the query image.

According to some implementations, a method is presented. The method includes storing an index for each of a plurality of image classes so that a plurality of indexes are stored, each index comprising a plurality of visual phrases present in at least one image classified in a respective image class. The method also includes de-duplicating at least one of the plurality of indexes. The method further includes obtaining a query image. The method further includes determining, using at least one of the plurality of indexes, a query image cost for a candidate image class. The method further includes associating, based on the determining, a label for the candidate image class with the query image.

The above implementations can optionally include one or more of the following. The de-duplicating can include: determining that a match term for a first visual phrase in the at least one of the plurality of indexes and a second visual phrase in the at least one of the plurality of indexes indicates a match, and removing the first visual phrase from the at least one of the plurality of indexes. The match term can include an appearance term applied to the first visual phrase and to the second visual phrase. The match term can include a residual error term applied to the first visual phrase and to the second visual phrase. The query image cost can include an appearance term applied to a visual phrase in the query image and to a visual phrase in an image in the candidate image class. The query image cost can include an residual error term applied to a visual phrase in the query image and to a visual phrase in an image in the candidate image class. The obtaining can include crawling at least a portion of the internet. The method can further include: receiving a textual search query, and providing the query image in response to the receiving. The query image cost for the candidate image class can be one of maximal and minimal as compared with a plurality of additional query image costs for a plurality of other image classes.

According to some implementations, a system is presented. The system includes a persistent memory storing an index for each of a plurality of image classes so that a plurality of indexes are stored, each index comprising a plurality of visual phrases present in at least one image classified in a respective image class. The system also include at least one processor configured to de-duplicate at least one of the plurality of indexes. The system further includes at least one processor configured to determine, using at least one of the plurality of indexes, a query image cost for a candidate image class. The system further includes at least one processor configured to associate, based on the query image cost, the candidate image class with the query image. The system further includes a persistent memory storing an indicia associated with the candidate image class in association with the query image.

The above implementations can optionally include one or more of the following. The at least one processor configured to de-duplicate at least one of the plurality of indexes can be further configured to determine that a match term for a first visual phrase in the at least one of the plurality of indexes and a second visual phrase in the at least one of the plurality of indexes indicates a match. The match term can include an appearance term applied to the first visual phrase and to the second visual phrase. The match term can include a residual error term applied to the first visual phrase and to the second visual phrase. The query image cost can include an appearance term applied to a visual phrase in the query image and to a visual phrase in an image in the candidate image class. The query image cost can include an residual error term applied to a visual phrase in the query image and to a visual phrase in an image in the candidate image class. The system can include least one processor configured to obtain the query image by crawling at least a portion of the internet. The system can further include a network interface configured to receive a textual search query, and at least one processor configured to provide the query image in response to the textual search query. The query image cost for the candidate image class can be one of maximal and minimal as compared with a plurality of additional query image costs for a plurality of other image classes.

According to some implementations, a computer readable medium is presented. The computer readable medium includes instructions which, when executed, cause at least one processor to: store an index for each of a plurality of image classes so that a plurality of indexes are stored, each index comprising a plurality of visual phrases present in at least one image classified in a respective image class, de-duplicate at least one of the plurality of indexes, obtain a query image, determine, using at least one of the plurality of indexes, a query image cost for a candidate image class, and associate, based on the determining, a label for the candidate image class with the query image.

Presented techniques include certain technical advantages. For example, the disclosed techniques can be used to automatically classify images into various coarse or fine categories. The classifications can be used to obtain similar images, and/or to build or augment indexes used by search engines to match search queries with the image search results.

### DESCRIPTION OF DRAWINGS

The accompanying drawings, which are incorporated in and constitute a part of this specification, illustrate implementations of the described techniques and together with the description, serve to explain the principles of described techniques. In the figures:

FIG. 1 is a schematic diagram of a system according to some implementations;

FIG. 2 is a schematic diagram illustrating an offset space according to some implementations;

FIG. 3 is a flowchart of an image recognition training method using local descriptor weights according to some implementations;

FIG. 4 is a flowchart of an image recognition method using local descriptor weights according to some implementations;

FIG. 5 is a flowchart of an image recognition training method using visual phrase matching according to some implementations; and

FIG. 6 is a flowchart of an image recognition method using visual phrase matching according to some implementations.

### DETAILED DESCRIPTION

In general, implementations provide techniques for classifying images. More particularly, implementations can be used to build or augment indexes that associate images with keywords.

This disclosure includes two sets of implementations for classifying images. Section I describes introductory material and technologies. Section II describes techniques for classifying images using local descriptor weights. Section III describes techniques for classifying images using visual phrase matching. Section IV presents additional information applicable to both sets of techniques.

Reference will now be made in detail to example implementations of the disclosed techniques, which are illustrated in the accompanying drawings. Where possible the same reference numbers will be used throughout the drawings to refer to the same or like parts.

### I. Introduction

As used herein, the term “image” refers to a computer-implementable two-dimensional likeness. In general, an image can be represented in a computer using a variety of file types, such as by way of non-limiting example: JPEG, GIF, BMP, etc.

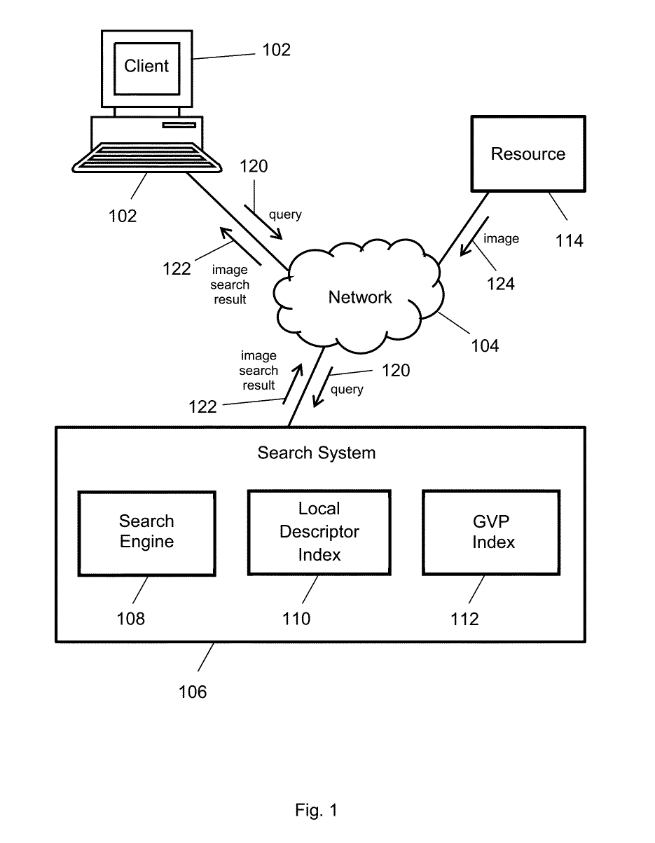

FIG. 1 is a schematic diagram of a system according to various implementations. Thus, FIG. 1 illustrates various hardware, software, and other resources that can be used in implementations of search system 106 according to presented techniques. Search system 106 is coupled to network 104, for example, the internet. Resource 114, which is communicatively coupled to network 104, can be, e.g., a web page or document. Resource 114 includes image 124. Client 102 is also coupled to network 104 such that search system 106 and client 102 are communicatively coupled. Client 102 can be a personal computer, tablet computer, desktop computer, or any other computing device.

Search system 106 can obtain image 124 from resource 114 using, e.g., a known web-crawling technique. At query time, search system 106 generates image search result 122 based on retrieved image 124. Image search result 122 can include both a version of image 124, e.g., a thumbnail image, and a uniform resource locator (URL) directed to resource 114 from which image 124 was obtained. Search system 106 uses one or more of the techniques disclosed herein to add data reflecting image search result 122 to either or both of local descriptor index 110 and geometry-preserving visual phrase (GVP) index 112. That is, the techniques disclosed herein can be used to build or add to local descriptor index 110 and GVP index 112.

Using a web browser, for example, a user of client 102 can send query 120 to search system 106 through network 104. The query can include textual terms and/or an image. Search system 106 receives query 120 and processes it using search engine 108. If the query includes an image, search engine 108 obtains textual terms corresponding to the image using the techniques disclosed herein. If the query contains textual terms, search engine 108 obtains textual terms directly from the query itself. Whether corresponding to an image in the query or originally present in the query, search engine 108 matches the obtained textual terms to keywords corresponding to image search result 122. Search engine 108 uses one or both of local descriptor index 110 and GVP index 112 to accomplish the matching.

Search system 106 conveys a responsive image search result 122 back to client 102 through network 104. Some implementations convey a number of image search results to client 102 in addition to image search result 122. Client 102 can display image search result 122, and any other image search results, using, for example, a web browser. The user of client 102 can click on image search result 122 to activate the associated URL that directs the user's browser to a web page that corresponds to resource 114 in which image 124 appeared.

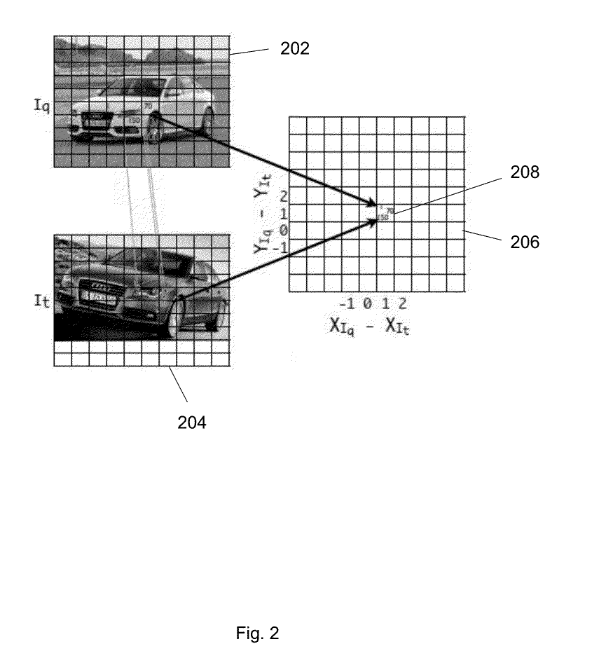

FIG. 2 is a schematic diagram illustrating an example visual phrase 208 according to some implementations. In particular, FIG. 2 depicts two images: query image I_{q} 202 and training image Iₜ 204. Both images 202, 204 include matching local descriptors, labeled with numerals 1, 70 and 150 in FIG. 2, which, as described in detail below, constitute visual phrase 208 as depicted in offset space 206.

A local descriptor, as is known, is a quantification of a local, e.g., small, part of an image. A local descriptor can be represented in electronic media, e.g., volatile or persistent memory, by: (1) an identification of, or an association with, an image from which it came, (2) an identification of where in the image the local descriptor is found, e.g., using Cartesian coordinates, and (3) a feature vector. A local descriptor can, by convention, reflect a patch of pixels centered about, or otherwise located by, the coordinates provided by (2). Such a patch can be square, rectangular, circular, or another shape. Various types of feature vectors according to (3) can be utilized in implementations. Example feature vectors can include data reflecting, any, or a combination, of: a color histogram of the pixels, a texture histogram of the pixels, a histogram of gradients of the pixels, and Fourier coefficients of the pixels. Thus, a local descriptor provides an identification and description of a relatively small feature in an image.

Offset space 206 plots matching local descriptors according to their relative positions in their respective images. Two local descriptors are considered to match if they are sufficiently similar as determined, e.g., by a similarity metric for their respective feature vectors exceeding a predetermined threshold. The x-axis of offset space 206 represents the difference in x coordinates between local descriptors in query image I_{q} 202 and training image Iₜ 204, and the y-axis of offset space 206 represents the difference in y coordinates between local descriptors in query image I_{q} 202 and training image Iₜ 204. To form offset space 206, the system, e.g., computer system 106 of FIG. 1, virtually parses each image I_{q} 202 and Iₜ 204 into unit squares. The system identifies local descriptors in each image, and then identifies matching local descriptors between images. That is, offset space 206 depicts matching local descriptors between query image I_{q} 202 and training image Iₜ 204 according to their relative shifts. The system determines the relative location of the matching local descriptors, possibly using a geometric transformation to account for, e.g., rotations, dilations or contractions, and plots them on offset space 206 accordingly. In FIG. 2, the depicted local descriptors in query image I_{q} 202 are shifted one unit horizontally and one unit vertically relative to their locations in training image Iₜ 204. Thus, offset space 206 plots representations of the matching local descriptors in the unit square at offset space coordinates (1, 1).

A “visual phrase”, also known as a “geometry-preserving visual phrase” or “GVP”, as used in this disclosure is a collection of local descriptors, or representations thereof, that appear in a single unit square in an offset space for two images. More generally, a visual phrase can correspond to local descriptors that appear in a single quantized portion, as opposed to a strict unit square, of an offset space. Thus, the local descriptors represented by numerals 1, 70 and 150 in FIG. 2 make up a visual phrase because they appear in the same unit square in offset space 206. In general, a visual phrase can indicate that a plurality of matching local descriptors appear in two different images in a similar arrangement.

### II. Image Classification Using Local Descriptor Weights

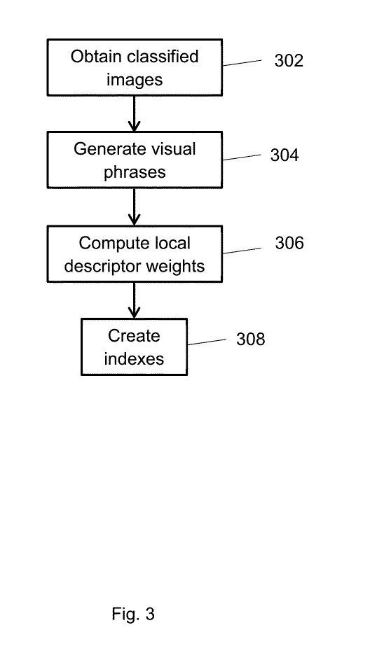

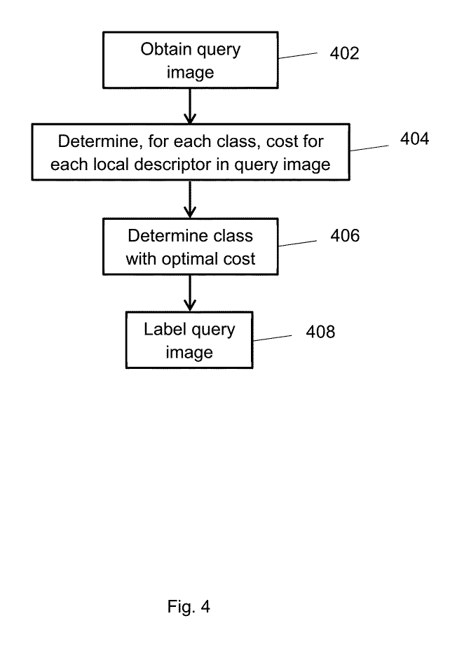

FIG. 3 is a flowchart of an image recognition training method using local descriptor weights according to some implementations. In particular, FIG. 3 depicts a technique for creating indexes for use in classifying images as described in detail below in reference to FIG. 4. The method of FIG. 3 can be implemented using, by way of non-limiting example, search system 106 of FIG. 1.

At block 302, the system obtains a set of classified training images. The training images, and any other images referred to herein, can be electronically represented in any of a variety of formats e.g., BMP, JPG, GIF, etc. Each training image can be classified according to a set of classes. Example classes can include specific classes, for example, for types of flowers and dogs, e.g., tulips, roses, daisies, etc.; poodles, schnauzers, rottweilers, etc. Each stored training image can be stored in association with an electronic representation of its classification. The classifications can be performed by humans, e.g., using crowdsourcing techniques. Alternately, or in addition, the system can classify training images based on text surrounding the image in the resource in which the image appeared, or based on image metadata, such as the image file name. The association between images and classes can be achieved using any of several different techniques, such as electronic labels or database relations. The system can obtain the training images by accessing them electronically, e.g., from coupled persistent memory, or over a network, e.g., network 104 of FIG. 1, from a remote source, a related entity, or a third party.

At block 304, the system generates visual phrases for the obtained training images. Each training image has associated local descriptors, which the system can obtain any point up to or including block 304. The system processes each training image, relative to its classification, to obtain visual phrases. For example, a training image I in class C can be considered as a query image as described above in reference to FIG. 2 and compared to every other image also in class C. If there are T images in class C, then this comparison implicates T−1 offset spaces, where each offset space corresponds to image I and to another image in class C. Each offset space provides zero or more visual phrases common to image I and to another image in class C.

The visual phrases can be stored, e.g., in persistent memory. In some implementations, each local descriptor is associated with an index numeral, and the system stores the visual phrases in terms of such index numerals instead of as the local descriptors themselves.

The procedure of treating each image as a query image in its respective class for the purpose of obtaining visual phrases can be repeated for each image in each image class, excluding duplicative comparisons.

At block 306, the system computes weights for each local descriptor in each training image in each class. Such weights take into account visual phrases as described presently. For a given local descriptor j in image I of class C, the associated weight wⱼ can be computed as, for example:

$${w}_{j} = {min}_{GVP ∈ X} \frac{1}{n ( GVP ) \vert GVP \vert} \qquad ( 1 )$$

In Equation (1), wⱼ is the weight for local descriptor j of image I. The term GVP represents a visual phrase. The function n(•) represents the number of times the visual phrase in its argument is repeated across all offset spaces corresponding to the image I and another image in the same class C. The function |•| is the cardinality operator. The term X is the set of both visual phrases, relative to image I and class C, that contain j, and intersections of visual phrases that contain j. In other words, X is the set of visual phrases that contain j and is closed under intersections. The system can electronically store the computed weights at this stage or later at block 308.

At block 308, the system builds, for each class, an index of local descriptors in the corresponding training images. Each index associates each local descriptor to its corresponding weight as computed at block 306. Each index can be an inverted index. Each index can be electronically stored, e.g., in persistent memory.

FIG. 4 is a flowchart of an image recognition method using local descriptor weights according to some implementations. In particular, FIG. 4 depicts a technique for classifying an image using the indexes created according to FIG. 3. The method of FIG. 4 can be implemented using, by way of non-limiting example, search system 106 of FIG. 1.

At block 402, the system obtains a query image. The system can obtain the query image by accessing it electronically, e.g., from persistent memory, or over a network, e.g., network 104 of FIG. 1, from a remote source, a related entity, or a third party. In some implementations, the query image can be obtained by crawling at least a portion of the web as part of building an index of images.

At block 404, the system determines a cost of the query image for each class. To that end, the system can first compute costs for each local descriptor of the query image for each class. For a given local descriptor j of query image I, and for a given class C, the associated cost can be computed as, for example:

$$Cost ( j , C ) = {min}_{k < L} {d}_{k} {w}_{k} \qquad ( 2 )$$

In Equation (2), Cost(j, C) represents the cost of local descriptor j of query image I as computed relative to class C. The term min is the minimum operator. The term L is a predetermined limit on the number of nearest neighbors considered, e.g., L can be set at any number between 2 and 50 inclusive. The term dₖ represents the distance between the j and the k-th nearest neighbor of j in class C, where the distance is computed using a similarity metric between feature vectors of local descriptors. The term wₖ represents the local descriptor weight for the k-th nearest neighbor of j in class C. Thus, wₖ can be retrieved from the index for C computed according to the technique described above in reference to FIG. 3. Thus, in general, the term Cost(j,C) reflects a minimal weighted distance between local descriptor j and local descriptors of images in class C.

To compute the cost of the query image for each class, the system can compute, for example:

$$Cost ( I , C ) = {\sum }_{j in I} Cost ( j , C ) \qquad ( 3 )$$

In Equation (3), Cost(I, C) represents the cost of the query image I relative to class C. The term Cost(j, C) represents the cost of a local descriptor j relative to class C, e.g., as computed as described above in reference to Equation (2). Thus, the cost of a query image relative to a class can be computed as the sum of the costs of its local descriptors relative to the class.

At block 406, the system determines the class with the optimal associated cost. Here, “optimal” can mean minimal or maximal, depending on the particular cost scheme employed. Using the cost scheme described above in reference to Equations (2) and (3), the optimal cost is the minimal cost. The system can make the determination of block 406 by, e.g., sorting the costs computed at block 404.

At block 408, the system labels the query image with the label associated with the class determined at block 406. The labeling can be accomplished by, for example, storing an electronic label or entering a database relation. Such techniques can be implemented in, e.g., persistent memory. The labeling result can be output to a user or to another computer process. The output can be over a network, e.g., network 104 of FIG. 1, to a remote repository, a related entity, or a third party, e.g., a remote user.

### III. Image Classification Using Visual Phrase Matching

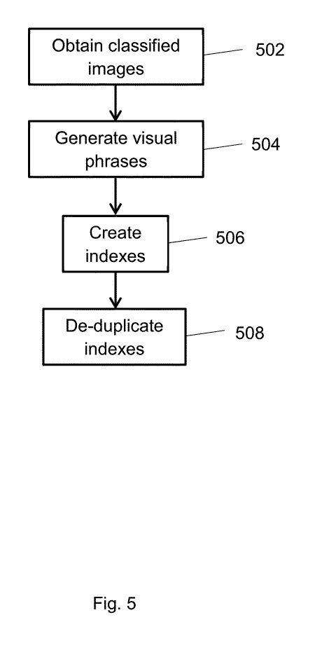

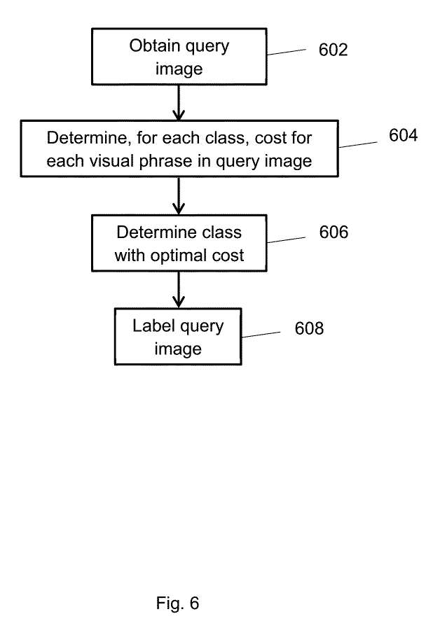

FIG. 5 is a flowchart of an image recognition training method using visual phrase matching according to some implementations. In particular, FIG. 5 depicts a technique for creating indexes that can be used in classifying images as described in reference to FIG. 6 below. The method of FIG. 5 can be implemented using, by way of non-limiting example, search system 106 of FIG. 1.

At block 502, the system obtains a set of classified training images. The training images can be obtained, electronically represented, classified, and stored in the same manner as described above in reference to block 302 of FIG. 3.

At block 504, the system generates visual phrases for the obtained training images. Each training image has associated local descriptors, which the system can obtain any point up to or including block 504. The system obtains and stores visual phrases for each image in each image class as described above in reference to block 304 of FIG. 3.

At block 506, the system builds, for each class, an index of visual phrases in the corresponding training images. Each index can be an inverted index. At block 506, each index can include each visual phrase from every training image associated with the class represented by the index. That is, at block 506, an index for a class can include each visual phrase that appears in any training image in that class.

At block 508, each index is de-duplicated. That is, the system can process each index to remove duplicative visual phrases. Two visual phrases GVPᵢ and GVPⱼ can be considered to match, e.g., be duplicative, if Ψ(GVPᵢ,GVPⱼ)>τ for a predetermined τ, where the formula Ψ(•,•) can be defined by, for example:

$$Ψ ( {GVP}_{i} , {GVP}_{j} ) = {max}_{H , π} ( 1 - exp ( - ( {ω}_{1} Λ ( {GVP}_{i} , {GVP}_{j} , π ) + {ω}_{2} Γ ( {GVP}_{i} , {GVP}_{j} , H , π ) ) ) ) \qquad ( 4 )$$

In Equation (4), exp represents exponentiation of the natural log base e. The symbol π(•) is a mapping between the local descriptors of GVPᵢ and GVPⱼ. The symbol Λ(•) is the appearance term between the constituent local descriptors of GVPᵢ and GVPⱼ under the mapping π(•). For example, Λ(•) can represent a sum of Euclidean distances in the offset space. The symbol H(•,•) represents a geometric transformation used to map the local descriptors of GVP, onto their respective local descriptors of GVPⱼ according to the mapping π(•). Such a geometric transformation can be, for example, affine, linear, a rotation, a contraction or a dilation. The symbol Γ(•,•,•,•) is the residual error of the geometric transformation H(•,•) between GVPᵢ and GVPⱼ under the mapping π(•). Thus, Γ(•,•,•,•) can represent the sum of the offsets between the geometrically transformed image local descriptors and the range local descriptors. The terms ω₁ and ω₂ represent relative importance weights for the appearance term and the geometric transformation terms, respectively. Values for ω₁ and ω₂ can be set by fiat, or can be learned according to comparisons between automatic and manual classifications of duplicative visual phrases. The term r can be set by fiat or learned in a similar manner. Applicable machine learning techniques for setting ω₁, ω₂, and τ include, for example, convex optimization, support vector machines, and randomized forests.

Thus, once the system builds the initial indexes at block 506, Equation (4) can be used to identify and remove duplicative GVPs from each index at block 508. That is, for any set of duplicative visual phrases initially in the index, the system can remove all but one such visual phrase from the index. Each index can be electronically stored, e.g., in persistent memory.

FIG. 6 is a flowchart of an image recognition method using visual phrase matching according to some implementations. In particular, FIG. 6 depicts a technique for classifying an image using the indexes created according to FIG. 5. The method of FIG. 6 can be implemented using, by way of non-limiting example, search system 106 of FIG. 1.

At block 602, the system obtains a query image. The system can obtain the query image in the same manner as described above in reference to block 402 of FIG. 4, that is, by accessing it electronically, e.g., from persistent memory, or over a network, e.g., network 104 of FIG. 1, from a remote source, a related entity, or a third party.

At block 604, the system determines a cost of the query image for each class. To that end, the system can first compute costs for each visual phrase of the query image for each class. For a given visual phrase GVPᵢ of query image I, and for a given class C, the associated cost can be computed as, for example:

$$Cost ( {GVP}_{i} , C ) = {min}_{{GVP}_{j} in C} Ψ ( {GVP}_{i} , {GVP}_{j} ) \qquad ( 5 )$$

In Equation (5), Cost(GVPᵢ, C) represents the cost of visual phrase GVPᵢ of query image I as computed relative to class C. The term min is the minimum operator. The term can be as described above in reference to Equation (4).

The system can compute the minimum value in Equation (5) by using the indexes obtained as described above in reference to FIG. 5. The computations for each class can be performed in parallel, or substantially in parallel. The known RANSAC computational algorithm can be employed for each computation.

In some implementations, an efficient sequential pruning technique can be used to compute the minimum value appearing in Equation (5). For example, for each class, the system can compute costs for visual phrases consisting of two local descriptors. The system can identify the pairs of local descriptors whose visual phrases have the highest scores. At the next step in the sequence, the system can compute the costs for visual phrases consisting of three local descriptors that include pairs of local descriptors identified at the prior stage. The system can identify the trios of local descriptors whose visual phrases have the highest scores, and at the next stage, the system can consider only those visual phrases with four local descriptors that include the highest scoring trios of local descriptors. This process can continue until a limit on visual descriptor cardinality is reached.

To compute the cost of the query image for each class, the system can compute, for example:

$$Cost ( I , C ) = {\sum }_{{GVP}_{i} in I} Cost ( {GVP}_{i} , C ) \qquad ( 6 )$$

In Equation (6), Cost(I, C) represents the cost of the query image I relative to class C. The term Cost(GVPᵢ, C) represents the cost of visual phrase GVPᵢ relative to class C, e.g., as computed as described above in reference to Equation (5). Thus, the cost of a query image relative to a class can be computed as the sum of the costs of its visual phrases relative to the class.

At block 606, the system determines the class with the optimal associated cost. Here, “optimal” can mean minimal or maximal, depending on the particular cost scheme employed. Using the cost scheme described above in reference to Equations (5) and (6), the optimal cost is the maximal cost. The system can make the determination of block 606 by, e.g., sorting the costs computed at block 604.

At block 608, the system labels the query image with the label associated with the class determined at block 606. The labeling can be accomplished by, for example, storing an electronic label or entering a database relation. Such techniques can be implemented in, e.g., persistent memory. The labeling result can be output to a user or to another computer process. The output can be over a network, e.g., network 104 of FIG. 1, to a remote repository, a related entity, or a third party, e.g., a remote user.

### IV. Additional Information

Regardless as to the particular image classification technique employed, the classifications can be used to assist an internet search engine. For example, a user, e.g., a user of client 102 of FIG. 1, can send query 120 over network 104 to search system 106. Search engine 108 can process query 120 and match it with one of the classes into which images are classified using one or both of local descriptor index 110 and GVP index 112 as described herein. Search system 106 can retrieve from storage image search result 122 associated with the matched class and provide it to the user together with other image search results responsive to the query.

In general, systems capable of performing the presented techniques can take many different forms. Further, the functionality of one portion of the system can be substituted into another portion of the system. Each hardware component can include one or more processors coupled to random access memory operating under control of, or in conjunction with, an operating system. The system can include network interfaces to connect with clients through a network. Such interfaces can include one or more servers. Appropriate networks include the internet, as well as smaller networks such as wide area networks (WAN) and local area networks (LAN). Networks internal to businesses or enterprises are also contemplated. Communications can be formatted according to, e.g., HTML or XML, and can be communicated using, e.g., TCP/IP or HTTP. Further, each hardware component can include persistent storage, such as a hard drive or drive array, which can store program instructions to perform the techniques presented herein. Other configurations of search system 106, associated network connections, and other hardware, software, and service resources are possible. Similarly, the techniques presented in reference to the accompanying flowcharts can be modified by, for example, removing or changing blocks.

The foregoing description is illustrative, and variations in configuration and implementation can occur. Other resources described as singular or integrated can in implementations be plural or distributed, and resources described as multiple or distributed can in implementations be combined. The scope of the described techniques is accordingly intended to be limited only by the following claims.

1-17. (canceled)

18. A computer-implemented method comprising:
obtaining a pair of images including a first image and a second image;
identifying feature points in the first image and feature points in the second image;
identifying pairs of matching feature points, where each pair of matching feature points includes (i) a respective first feature point in the first image, and (ii) a respective second feature point in the second image that is indicated as corresponding to the respective first feature point in the first image;
for each of the identified pairs of matching feature points, determining (i) a respective first position of the first feature point within the first image, (ii) a respective second position of the second feature point within the second image, and (iii) an offset between the first position and the second position;
determining a set of pairs of matching feature points that share a same or similar determined offset; and
storing the set of pairs of matching feature points that share a same or similar determined offset for the pair of images.

19. The method of claim 18, wherein the offset between the first position and the second position comprises:
a horizontal value representing a difference in horizontal location of the first position and the second position; and
a vertical value representing a difference in vertical location of the first position and the second position.

20. The method of claim 18, wherein determining a set of pairs of matching feature points that share a same or similar determined offset comprises:
identifying a predetermined range for offsets;
identifying determined offsets that are within the predetermined range for offsets; and
selecting the identified pairs of matching feature points that are associated with identified determined offsets that are within the predetermined range for offsets.

21. The method of claim 20, wherein the predetermined range for offsets comprises a predetermined range covered by a square of a grid that includes squares that cover various non-overlapping predetermined ranges for offsets.

22. The method of claim 18, comprising:
determining a second set of pairs of matching feature points that share a same or similar second determined offset that is different from the determined offset; and
storing the second set of pairs of matching feature points that share a same or similar second determined offset that is different from the determined offset for the pair of images.

23. The method of claim 18, wherein the feature points are visual feature points representing groups of pixels within images.

24. The method of claim 18, wherein the respective first position of the first feature point within the first image are expressed in Cartesian coordinates.

25. A system comprising:
one or more computers and one or more storage devices storing instructions that are operable, when executed by the one or more computers, to cause the one or more computers to perform operations comprising:
obtaining a pair of images including a first image and a second image;
identifying feature points in the first image and feature points in the second image;
identifying pairs of matching feature points, where each pair of matching feature points includes (i) a respective first feature point in the first image, and (ii) a respective second feature point in the second image that is indicated as corresponding to the respective first feature point in the first image;
for each of the identified pairs of matching feature points, determining (i) a respective first position of the first feature point within the first image, (ii) a respective second position of the second feature point within the second image, and (iii) an offset between the first position and the second position;
determining a set of pairs of matching feature points that share a same or similar determined offset; and
storing the set of pairs of matching feature points that share a same or similar determined offset for the pair of images.

26. The system of claim 25, wherein the offset between the first position and the second position comprises:
a horizontal value representing a difference in horizontal location of the first position and the second position; and
a vertical value representing a difference in vertical location of the first position and the second position.

27. The system of claim 25, wherein determining a set of pairs of matching feature points that share a same or similar determined offset comprises:
identifying a predetermined range for offsets;
identifying determined offsets that are within the predetermined range for offsets; and
selecting the identified pairs of matching feature points that are associated with identified determined offsets that are within the predetermined range for offsets.

28. The system of claim 27, wherein the predetermined range for offsets comprises a predetermined range covered by a square of a grid that includes squares that cover various non-overlapping predetermined ranges for offsets.

29. The system of claim 25, the operations comprising:
determining a second set of pairs of matching feature points that share a same or similar second determined offset that is different from the determined offset; and
storing the second set of pairs of matching feature points that share a same or similar second determined offset that is different from the determined offset for the pair of images.

30. The system of claim 25, wherein the feature points are visual feature points representing groups of pixels within images.

31. The system of claim 25, wherein the respective first position of the first feature point within the first image are expressed in Cartesian coordinates.

32. A non-transitory computer-readable medium storing software comprising instructions executable by one or more computers which, upon such execution, cause the one or more computers to perform operations comprising:
obtaining a pair of images including a first image and a second image;
identifying feature points in the first image and feature points in the second image;
identifying pairs of matching feature points, where each pair of matching feature points includes (i) a respective first feature point in the first image, and (ii) a respective second feature point in the second image that is indicated as corresponding to the respective first feature point in the first image;
for each of the identified pairs of matching feature points, determining (i) a respective first position of the first feature point within the first image, (ii) a respective second position of the second feature point within the second image, and (iii) an offset between the first position and the second position;
determining a set of pairs of matching feature points that share a same or similar determined offset; and
storing the set of pairs of matching feature points that share a same or similar determined offset for the pair of images.

33. The medium of claim 32, wherein the offset between the first position and the second position comprises:
a horizontal value representing a difference in horizontal location of the first position and the second position; and
a vertical value representing a difference in vertical location of the first position and the second position.

34. The medium of claim 32, wherein determining a set of pairs of matching feature points that share a same or similar determined offset comprises:
identifying a predetermined range for offsets;
identifying determined offsets that are within the predetermined range for offsets; and
selecting the identified pairs of matching feature points that are associated with identified determined offsets that are within the predetermined range for offsets.

35. The medium of claim 34, wherein the predetermined range for offsets comprises a predetermined range covered by a square of a grid that includes squares that cover various non-overlapping predetermined ranges for offsets.

36. The medium of claim 32, the operations comprising:
determining a second set of pairs of matching feature points that share a same or similar second determined offset that is different from the determined offset; and
storing the second set of pairs of matching feature points that share a same or similar second determined offset that is different from the determined offset for the pair of images.

37. The medium of claim 32, wherein the feature points are visual feature points representing groups of pixels within images.
